(19) United States
(12) Patent Application Publication
(10) Pub. No.: US 2007/0229488 A1
(43) Pub. Date: Oct. 4, 2007

(54) COMPUTER SYSTEM CAPABLE OF OPERATING FUNCTIONS ACCORDING TO A SCENE CHANGE AND METHOD THEREOF

(76) Inventors: Jing-Shun Lin, I-Lan Hsien (TW); Chao-Lien Tsai, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/693,703

(22) Filed: Mar. 29, 2007

(30) Foreign Application Priority Data
Mar. 31, 2006 (TW) 095111642

(51) Int. Cl. G09G 5/00

(52) U.S. Cl. 345/213

(57) ABSTRACT

A computer system includes an image capturing module for capturing a first image, a scene generating means for generating a background image according to the first image, a scene comparing means for comparing a second image captured by the image capturing module with the background image so as to generate a comparison result, and a control means for controlling a power consumption mode of the computer system according to the comparison result.

### BACKGROUND OF THE INVENTION

1. Field of the Invention

The present invention relates to a computer system capable of operating functions according to a scene change and a method thereof, and more particularly, to a computer system capable of controlling a power consumption mode according to a comparison of an image captured by an image capturing module and a background image and a method thereof.

2. Description of the Prior Art

Generally a power saving mechanism of a display monitor or a screen saving mechanism is provided by a screen saving application program of an operating system or a plug-in program. It depends on a status of operating input interfaces (keyboard or mouse) to determine whether a screen saving mode, shutting down the display monitor, shutting down a hard disk, or a system standby mode is activated. For example, the screen saving mode of the display monitor can be activated when the system does not receive any signal from the input interfaces during a predetermined period. For example, when a user does not operate a keyboard or a mouse in five minutes, the screen saving mode of the display monitor can be activated. The mechanism mentioned above has following disadvantages. If the predetermined period is too short, the screen saving mode, shutting down the display monitor, shutting down a hard disk, or the system standby mode may be activated when the user browses a document and does not touch the input interfaces. On the other hand, if the predetermined period is too long, the screen saving mode, shutting down the display monitor, shutting down a hard disk, or the system standby mode will be activated only after a long period. It is not very effective for a power saving effect. There is a need to find an effective power saving mechanism for the system and the display monitor.

### SUMMARY OF THE INVENTION

It is therefore a primary objective of the claimed invention to provide a computer system capable of controlling a power consumption mode according to a comparison of an image captured by an image capturing module and a background image and a method thereof for solving the above-mentioned problem.

According to the claimed invention, a computer system includes an image capturing module for capturing a first image, a scene generating means for generating a background image according to the first image, a scene comparing means for comparing a second image captured by the image capturing module with the background image so as to generate a comparison result, and a control means for controlling a power consumption mode of the computer system according to the comparison result.

According to the claimed invention, a method for controlling a computer system according to a scene change includes: (a)capturing an image; (b)generating a background image; (c)comparing the image captured in step (a) with the background image so as to generate a comparison result; and

(d)controlling a power consumption mode of the computer system according to the comparison result in step (c).

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of a computer system according to a preferred embodiment of the present invention.

FIG. 2 is a diagram of the computer system according to the preferred embodiment of the present invention.

FIG. 3 is a flowchart of controlling the computer system according to a scene change according to the preferred embodiment of the present invention.

### DETAILED DESCRIPTION

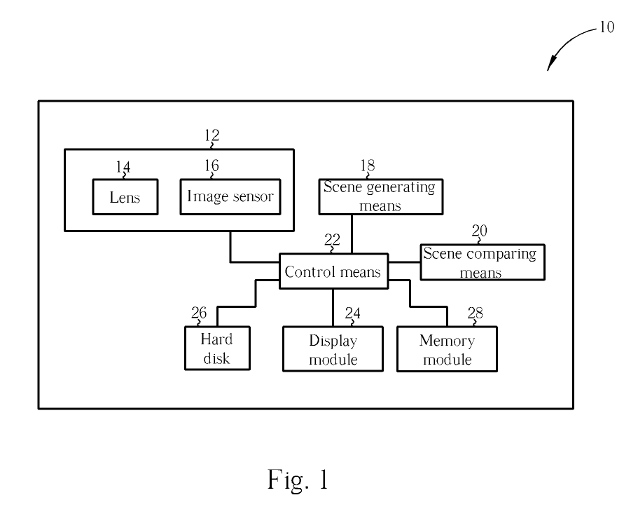

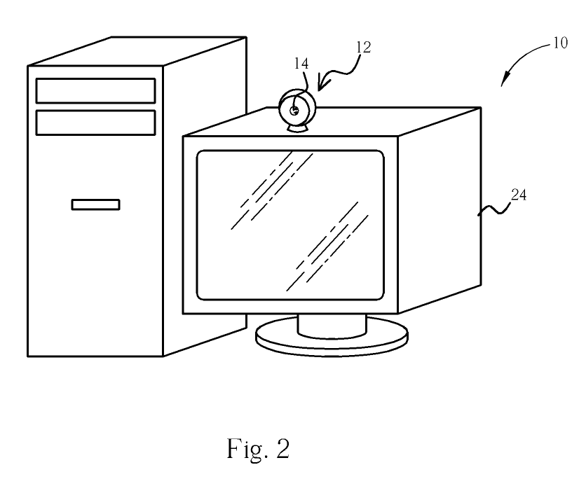

Please refer to FIG. 1 and FIG. 2. FIG. 1 is a functional block diagram of a computer system 10 according to a preferred embodiment of the present invention. FIG. 2 is a diagram of the computer system 10 according to the preferred embodiment of the present invention. The computer system 10 can be a personal computer, a notebook computer, and so on. The computer system includes an image capturing module 12 for capturing images. The image capturing module 12 can be a web cam. The image capturing module 12 includes a lens 14 for receiving light emitted from images, and an image sensor 16 for converting the light into an electrical signal. The image sensor 16 can include a plurality of charge coupled devices (CCD) or a plurality of complementary metal-oxide semiconductors (CMOS). The computer system 10 further includes a scene generating means 18 for generating a background image according to the images captured by the image capturing module 12. The scene generating means 18 can be a program code or a logic circuit. The computer system 10 further includes a scene comparing means 20 for comparing the images captured by the image capturing module 12 with the background image generated by the scene generating means 18 so as to generate a comparison result. The scene comparing means 20 can be a program code or a logic circuit. The computer system 10 further includes a control means 22 for controlling a power consumption mode of the computer system 10 according to the comparison result. The control means 22 can be a program code or a logic circuit. The computer system 10 further includes a display module 24, a hard disk 26, and a memory module 28. The control means 22 is capable of controlling the display module 24 and the hard disk 26 according to the comparison result. The memory module 28 is for storing the background image.

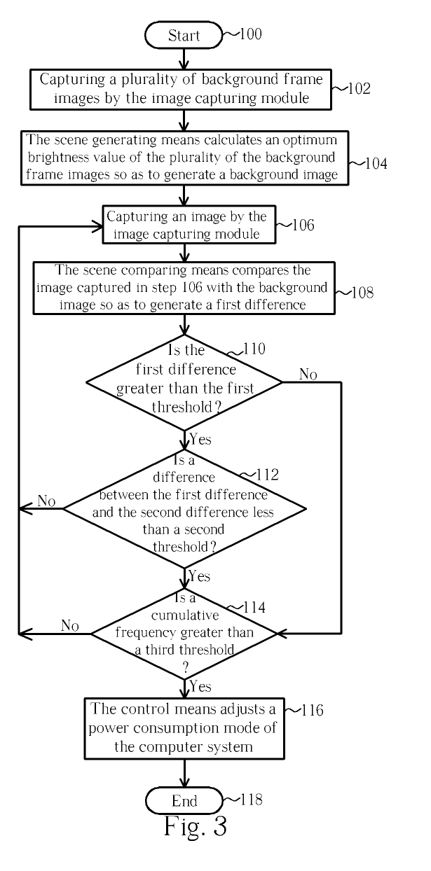

Please refer to FIG. 3. FIG. 3 is a flowchart of controlling the computer system 10 according to a scene change according to the preferred embodiment of the present invention. The method includes following steps:

Step 100: Start.

Step 102: Capturing a plurality of background frame images by the image capturing module 12.

Step 104: The scene generating means 18 calculates an optimum brightness value of the plurality of the background frame images so as to generate a background image.

Step 106: Capturing an image by the image capturing module 12.

Step 108: The scene comparing means 20 compares the image captured in step 106 with the background image so as to generate a first difference.

Step 110: Comparing the first difference with a first threshold. When the first difference is greater than the first threshold, go to step 112; and when the first difference is less than the first threshold, go to step 114.

Step 112: Comparing the first difference with a second difference generated by comparing a last captured image with the background image. When a difference between the first difference and the second difference is less than a second threshold, go to step 114; and when the difference between the first difference and the second difference is greater than the second threshold, go to step 106.

Step 114: Is a cumulative frequency of the first difference being less than the first threshold or not only the first difference being greater than the first threshold but also the difference between the first difference and the second difference being less than the second threshold greater than a third threshold? If yes, go to step 116; if no, go to step 106.

Step 116: The control means 22 adjusts a power consumption mode of the computer system 10.

Step 118: End.

The detailed description is introduced as follows. First a user can use the image capturing module 12 to capture the plurality of background frame images where the computer system 10 is located continuously, such as capturing one hundred of background frame images continuously. A static object or a dynamic object of the plurality of background frame images can be analyzed so as to generate the background image, and the background image can be stored in the memory module 28 for a basis of judging the scene. As for the way to generate the background image, a parameter of each pixel of the plurality of background frame images is calculated so as to generate the optimum background image. The parameter can be a parameter of the image characteristic, such as a brightness value of a pixel. For example, a mean brightness value of each pixel of the plurality of background frame images is calculated wherein a bright value deviating from a standard deviation can be omitted. The mean brightness value of each pixel of the plurality of background frame images is the brightness value of each pixel of the background image so as to generate the background image.

Afterward the scene comparing means 20 compares a real scene with the background image stored in the memory module 28 so as to determine whether the user is positioned in front of the computer system 10, that is, utilizing the computer system 10 for a basis of activating a screen saving mode, shutting down the display module 24, shutting down the hard disk 26, or activating a standby mode of the hard disk 26. In other words, the image capturing module 12 captures an image of a real scene, and the scene comparing means 20 compares the image captured by the image capturing module 12 in step 106 with the background image so as to generate the first difference. As for the way to generate the first difference, a sum of a parameter difference of each pixel between the image captured by the image capturing module 12 in step 106 and the background image is calculated to be the first difference. The parameter difference can be a parameter difference of the image characteristic, such as a brightness difference of a pixel. For example, a sum of a brightness difference of each pixel between the image captured by the image capturing module 12 in step 106 and the background image is calculated to be the first difference.

The first difference is compared with the first threshold for determining whether the real scene corresponds to the background image. If the first difference is greater than the first threshold, the real scene does not correspond to the background image. If the first difference is less than the first threshold, the real scene corresponds to the background image. When the real scene corresponds to the background image, go to step 114. When repeating comparing a plurality of captured images with the background image for the cumulative frequency and the cumulative frequency of the first difference being less than the first threshold is greater than the third threshold, it means the user is not positioned in front of the computer system 10 during the duration corresponding to the third threshold. Then the control means 22 adjusts the power consumption mode of the computer system 10. If the cumulative frequency is less than the third threshold, the above-mentioned comparison of the first difference and the first threshold is repeated. It can prevent activating a power saving mechanism too early before the user comes back to the computer system 10 within the duration corresponding to the third threshold.

In step 110, when the real scene does not correspond to the background image, that is, the first difference is greater than the first threshold, it is still possible that the user leaves the front of the computer system 10. For example, a cup is positioned in front of the computer system 10 so that the real scene does not correspond to the background image. Hence the comparison in step 112 is needed. The second difference generated by comparing a last captured image with the background image is compared with the first difference for determining whether an object in the real scene is moving. If an object in the real scene is not moving, the difference between the first difference and the second difference is less than the second threshold so that there is no change of the scene. If an object in the real scene is moving, the difference between the first difference and the second difference is greater than the second threshold so that there is a change of the scene. When there is no change of the scene, go to step 114. When repeating comparing a plurality of captured images with the background image for the cumulative frequency and the cumulative frequency of not only the first difference being greater than the first threshold but also the difference between the first difference and the second difference being less than the second threshold is greater than the third threshold, it means no object is moving within the duration corresponding to the third threshold. That is, there is no change of the scene within the duration corresponding to the third threshold. Then the control means 22 adjusts the power consumption mode of the computer system 10. If the cumulative frequency is less than the third threshold, go to step 106. It can prevent activating a power saving mechanism too early before the user comes back to the computer system 10 within the duration corresponding to the third threshold.

At last, when the cumulative frequency is greater than the third threshold, it means the user is not positioned in front of the computer system 10 right now and is not using the computer system 10. The control means 22 will adjust the power consumption mode of the computer system 10 for saving electricity. For example, the control means can activate a screen saving mode of the display module 24, shut down the display module 24, shut down the hard disk 26, or activate a standby mode of the hard disk 26 for saving electricity of the computer system 10.

In contrast to the prior art, the present invention can activate a power saving mechanism according to a scene change. It can determine whether the user is positioned in front of the computer system for using the computer system truly. The present invention provides an effective power saving mechanism for a computer system and a display monitor thereof.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A computer system comprising:
an image capturing module for capturing a first image;
a scene generating means for generating a background image according to the first image;
a scene comparing means for comparing a second image captured by the image capturing module with the background image so as to generate a comparison result; and
a control means for controlling a power consumption mode of the computer system according to the comparison result.

2. The computer system of claim 1 further comprising a memory module for storing the background image.

3. The computer system of claim 1 wherein the image capturing module comprises a lens for receiving an image, and an image sensor for converting the image into an electrical signal.

4. The computer system of claim 3 wherein the image sensor comprises a plurality of charge coupled devices (CCD).

5. The computer system of claim 3 wherein the image sensor comprises a plurality of complementary metal-oxide semiconductors (CMOS).

6. The computer system of claim 1 further comprising a display module wherein the control means controls the display module according to the comparison result.

7. The computer system of claim 1 further comprising a hard disk wherein the control means controls the hard disk according to the comparison result.

8. A method for controlling a computer system according to a scene change comprising:
(a) capturing an image;
(b) generating a background image;
(c) comparing the image captured in step (a) with the background image so as to generate a comparison result; and
(d) controlling a power consumption mode of the computer system according to the comparison result in step (c).

9. The method of claim 8 wherein step (b) comprises capturing a plurality of background frame images so as to generate the background image according to the plurality of background frame images.

10. The method of claim 9 wherein step (b) further comprises calculating an optimum brightness value of the plurality of background frame images so as to generate the background image.

11. The method of claim 8 wherein step (c) comprises comparing the image captured in step (a) with the background image so as to generate a first difference and comparing the first difference with a first threshold, and step (d) comprises controlling the power consumption mode of the computer system according to a comparison result of the first difference and the first threshold.

12. The method of claim 11 wherein step (d) further comprises controlling the computer system to execute a power saving mode when the first difference is less than the first threshold.

13. The method of claim 11 wherein step (c) further comprises comparing the first difference with a second difference generated by comparing a last captured image with the background image, and step (d) further comprises controlling the power consumption mode of the computer system according to the comparison result of the first difference and the first threshold and a comparison result of the first difference and the second difference.

14. The method of claim 13 wherein step (d) further comprises controlling the computer system to execute a power saving mode when the first difference is greater than the first threshold and a difference between the first difference and the second difference is less than a second threshold.

15. The method of claim 8 wherein step (d) comprises activating a screen saving mode of a display module of the computer system according to the comparison result in step (c).

16. The method of claim 8 wherein step (d) comprises shutting down a display module of the computer system according to the comparison result in step (c).

17. The method of claim 8 wherein step (d) comprises shutting down a hard disk of the computer system according to the comparison result in step (c).

18. The method of claim 8 wherein step (d) comprises activating a standby mode of a hard disk of the computer system according to the comparison result in step (c).
